(19) United States
(12) Patent Application Publication
(10) Pub. No.: US 2010/0322049 A1
(43) Pub. Date: Dec. 23, 2010

(54) OPTICAL DISC DRIVE DEVICE

(76) Inventor: Yutaka Yamanaka, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/735,996

(22) PCT Filed: Mar. 24, 2009
(86) PCT No.: PCT/JP2009/055832

§ 371 Date: Aug. 31, 2010

(30) Foreign Application Priority Data
Mar. 27, 2008 (JP) 2008-082969

(51) Int. Cl. G11B 20/00

(52) U.S. Cl. 369/47.15; G9B/20

(57) ABSTRACT

A plurality of drive units are divided into two groups and controlled. While almost a half of the drive units perform recording on or reproducing from a recording layer in a first format, remaining almost half of drive units perform recording on or reproducing from a recording layer in a second format.

### TECHNICAL FIELD

The present invention relates to an optical disc drive device performing recording or reproducing simultaneously on or from a plurality of optical discs, and to a recording/reproducing method thereof.

### BACKGROUND ART

In an optical disc technique in practical use, widely used is a discoidal optical disc medium with a structure having therein a recording layer where a spiral track is formed. CDs (Compact Discs) and DVD (Digital Versatile Discs) also have such a medium structure, and a read-only medium and a recordable medium have been realized depending on a difference in a material of the recording layer.

Recording or reproducing is performed while the optical disc medium set at a spindle in a drive device is in rotation. The optical disc medium set at the spindle can be easily replaced. Therefore, there is an advantage that total accessible recording capacity can easily be increased by, for example, combination with a changer mechanism that replaces the optical disc medium. Furthermore, it is also possible to increase an apparent data transfer velocity of the drive device by recording or reproducing simultaneously on a plurality of optical disc media.

In a case where recording or reproducing is performed on spiral tracks formed on the optical disc medium at a constant linear velocity, that is, a constant data transfer velocity, spindle control is performed in a manner such that a rotation velocity of the medium is fast on tracks on an inner circumference side and slow on tracks on an outer circumference side. To increase the transfer velocity, it is effective to speed up the rotation velocity. However, there is an obvious limit on the number of revolutions that can be realized stably with mechanical structures of the spindle and the optical disc medium. For example, the limit is said to be approximately 10,000 rpm (Revolutions per Minute) for the DVDs. This number of revolutions does not depend on a track radius position where recording or reproducing is performed. Thus, the data transfer velocity in a limit condition is different between the tracks on the inner circumference side and the tracks on the outer circumference side. As a result, a maximum data transfer velocity that can always be realized in the drive device is controlled in a condition that the transfer velocity on the inner circumference side is slowest.

To solve this problem, Japanese Patent Publication No. Heisei 11-110888A discloses a method of simultaneously driving a plurality of drive units. In this method, an optical disc medium of an MCAV (Modified Constant Angular Velocity) type or a ZCAV (Zone Constant Angular Velocity) type including a plurality of sectors is used. Of the plurality of drive units, some perform accessing from a sector on outer circumference toward a sector on inner circumference, while remaining drive units perform accessing from the sector on the inner circumference toward the sector on the outer circumference. Consequently, shown is a method of uniformizing a data transfer velocity when data signals from the plurality of drive units are synthesized.

However, when an optical disc medium with the same structure is used for any of the drive units, a direction of a spiral track in each sector is unidirectional either from the outer circumference to the inner circumference or from the inner circumference to the outer circumference. Thus, actual access is as shown in, for example, FIGS. 1A and 1B. FIGS. 1A and 1B show cross sections of the optical disc medium and access sequence of the sectors. A recording layer 2 inside the optical disc medium has a track structure of a spiral shape from the inner circumference to the outer circumference. This track is divided into a plurality of sectors 30 in a radial direction. FIG. 1A shows the access sequence for the drive unit performing accessing from the sector on the inner circumference toward the sector on the outer circumference. The drive unit performing accessing from the sector on the inner circumference toward the sector on the outer circumference may perform accessing, as shown in FIG. 1A, along the spiral tracks in order of an arrow a, an arrow b, an arrow c, and an arrow d. On the other hand, FIG. 1B shows the access sequence for the drive unit performing accessing from the sector on the outer circumference toward the sector on the inner circumference. The drive unit performing accessing from the sector on the outer circumference toward the sector on the inner circumference performs accessing, as shown in FIG. 1B, in order of an arrow e, an arrow f, an arrow g, and an arrow h. Thus, between the sectors, the tracks radially distant from each other need to be accessed, which wastes transfer time.

Preparing two types of optical disc media with different spiral directions can solve the problem described above, but requires additional time and effort for managing the different types of optical disc media without any mistake.

Japanese Patent Publication No. 2002-150607A discloses a technique related to an optical recording medium. This optical recording medium has a plurality of recording layers with a double spiral structure that permits recording of information on both a land track and a groove track. On this optical recording medium, a spiral of the first recording layer of these recording layers is in a forward direction and a spiral of the second recording layer of these recording layers is in a backward direction. At the first recording layer, first information is recorded on either of the land track and the groove track in a direction from inner circumference toward outer circumference of the optical recording medium. At the second recording layer, second information following the first information is recorded on either of the land track and the groove track in a direction from the outer circumference toward the inner circumference of the optical recording medium.

Japanese Patent Publication No. 2002-279734A discloses a technique related to a disc device. This disc device uses a two-layer disc'medium whose spiral direction of a track of a first layer and spiral direction of a track of a second layer are opposite to each other. This disc device has the following features. Specifically, a first head and a second head are respectively arranged at the first layer and the second layer of the disc medium. The number of disc revolutions is constant. The first head performs scanning in the first layer from inner circumference toward outer circumference. At the same time, the second head performs scanning in the second layer from the outer circumference toward the inner circumference. A ratio between a bit rate of data recorded or reproduced on or from the first head and a bit rate of data recorded or reproduced on or from the second head is brought into rough agreement with a ratio of disc diameters at head positions.

### SUMMARY

An object of the present invention is to solve a problem as described above and provide an optical disc drive device capable of keeping a data transfer velocity constant by use of a plurality of optical disc media of the same type.

In an aspect of the present invention, an optical disc drive device includes a plurality of drive units and a control section. Each of the plurality of drive units performs recording or reproducing on an optical disc medium. The optical disc medium has a plurality of recording layers where a spiral track is formed and recording or reproducing is performed with light entering from a same incidence plane through a transparent substrate. Almost half of the plurality of recording layers provided in each optical disc media has a first format in which recording or reproducing is performed along the spiral track to be scanned from inner circumference to outer circumference. The remaining almost half of the plurality of recording layers has a second format in which recording or reproducing is performed along the spiral track to be scanned from the outer circumference to the inner circumference. Moreover, the plurality of drive units are divided into a first group of drive units and a second group of drive units provided in almost the same quantity as that of the first group to be controlled. The control section controls operation of the first group of drive units and the second group of drive units in a manner such that a first operation state and a second operation state are provided. The first operation state is an operation state in which the second group of drive units performs recording or reproducing on the recording layers in the second format while the first group of drive units performs recording or reproducing on the recording layers in the first format. The second operation state is an operation state in which the second group of drive units performs recording or reproducing on the recording layers in the first format while the first group of drive units performs recording or reproducing on the recording layers in the second format.

In another aspect of the present invention, an optical disc medium recording/reproducing method is an optical disc medium recording/reproducing method of performing in a plurality of drive units recording or reproducing on an optical disc medium having a plurality of recording layers where a spiral track is formed. This optical disc medium can perform recording or reproducing with light entering from the same incidence plane through a transparent substrate. Almost half of the plurality of recording layers has a first format in which recording or reproducing is performed along the spiral track to be scanned from inner circumference to outer circumference. The remaining almost half of the plurality of recording layers has a second format in which recording or reproducing is performed along the spiral track to be scanned from the outer circumference to the inner circumference. The optical disc medium recording/reproducing method includes: a step of dividing; a step of performing recording or reproducing in a first operation state; and a step of performing recording or reproducing in a second operation state. In the step of dividing, the plurality of drive units are divided into a first group of drive units and a second group of drive units provided in almost the same quantity as that of the first group. In the step of performing recording or reproducing in the first operation state, the second group of drive units performs recording or reproducing on the recording layers in the second format while the first group of drive units performs recording or reproducing on the recording layers in the first format. In the second operation state, the second group of drive units performs recording or reproducing on the recording layers in the first format while the first group of drive units performs recording or reproducing on the recording layers in the second format.

According to the present invention, an optical disc drive device can be provided which keeps a constant data transfer velocity by use of a plurality of identical optical disc media.

### BRIEF DESCRIPTION OF THE DRAWINGS

Objects, effects, and features of the present invention described above will be more clarified by a description of an embodiment with the accompanying drawings.

FIGS. 1A and 1B are sectional views showing a sectional structure of an optical disc medium and access sequence of sectors.

FIGS. 2A to 2C are diagrams showing examples of the optical disc medium.

FIG. 3 is a diagram showing an example of sectional structure of an optical disc medium with two recording layers.

FIG. 4 is a block diagram illustrating an optical drive device according to an embodiment of the present invention.

FIG. 5A is a diagram showing the access sequence in a case where the first recording layer is accessed after a 0-th recording layer.

FIG. 5B is a diagram showing the access sequence in a case where the 0-th recording layer is accessed after the first recording layer.

FIGS. 6A to 6D are pattern diagrams illustrating operation states of an optical disc drive device for an optical disc medium with a two-layer structure.

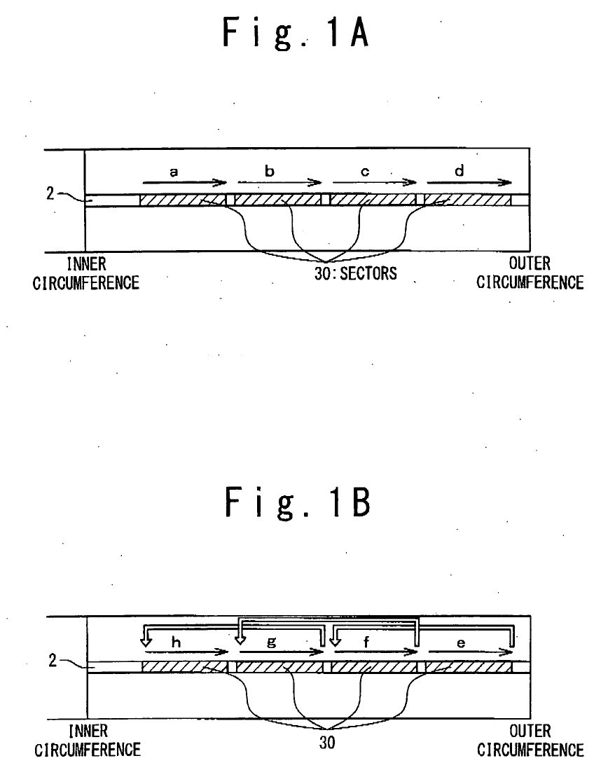

### DESCRIPTION OF PREFERRED EMBODIMENTS

Referring to the accompanying drawings, an optical disc drive device according to an embodiment of the present invention will be described below.

### First Embodiment

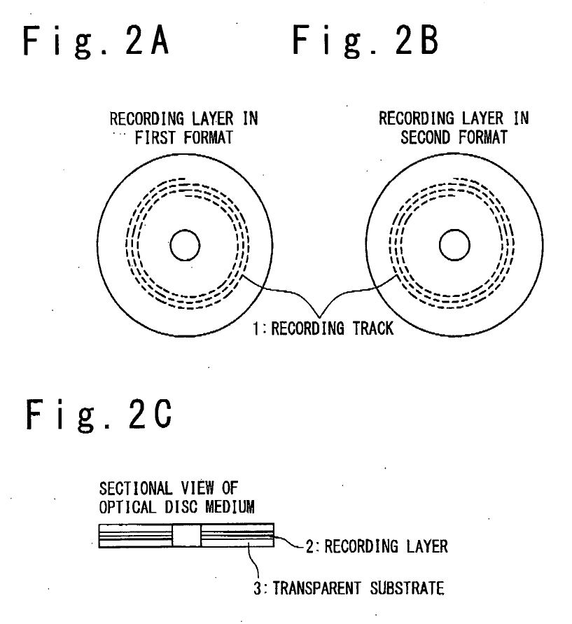

FIGS. 2A to 2C are diagrams showing examples of an optical disc medium used in the present invention. FIG. 2A is a plan view illustrating a first format in this optical disc. Similarly, FIG. 2B is a plan view illustrating a second format in this optical disc. FIG. 2C is a sectional view illustrating a stacking structure of this optical disc.

This optical disc medium, as shown in the sectional structure of FIG. 2C, has a plurality of recording layers 2 accessible via a transparent substrate 3. Almost half of the plurality of recording layers 2 has the first format shown in FIG. 2A. In the first format, a recording track 1 of a spiral shape is formed in a manner such that recording or reproducing is performed from inner circumference toward outer circumference. The remaining recording layers 2 have the second format shown in FIG. 2B. In the second format, a recording track 1 of a spiral shape is formed in a direction opposite to that of the first format in a manner such that recording or reproducing is performed from outer circumference toward inner circumference.

Order of the recording layers in the first format and the recording layers in the second format in a stacking direction are not specified, but it is preferable that they be alternately and sequentially stacked. In this case, there is an advantage that all the recording layers can be sequentially accessed in short time only by operation of jumping of a focal point of a condensed beam from a track terminal end of each recording layer to a track starting end of the adjacent recording layer. That is, the focal point of the condensed beam only moves in a thickness direction of the optical disc, involving no movement of an optical head or involving this movement, if any, over a short distance.

FIG. 3 is a diagram showing an example of a sectional structure of an optical disc medium provided with two recording layers. The 0^{-th} recording layer has the first format. Therefore, at a recording track formation section 5 indicating a region of the recording layer where a recording track is formed, a condensed beam, following the track, moves from an inner circumference side toward an outer circumference side. The first recording layer has the second format. At a recording track formation section 5 of the first recording layer, the condensed beam, following the track, moves from the outer circumference side toward the inner circumference side. Such an optical disc medium having two recording layers with opposite spiral structures has already been used in DVDs and the like, and serves as a conventional technique in terms of manufacture.

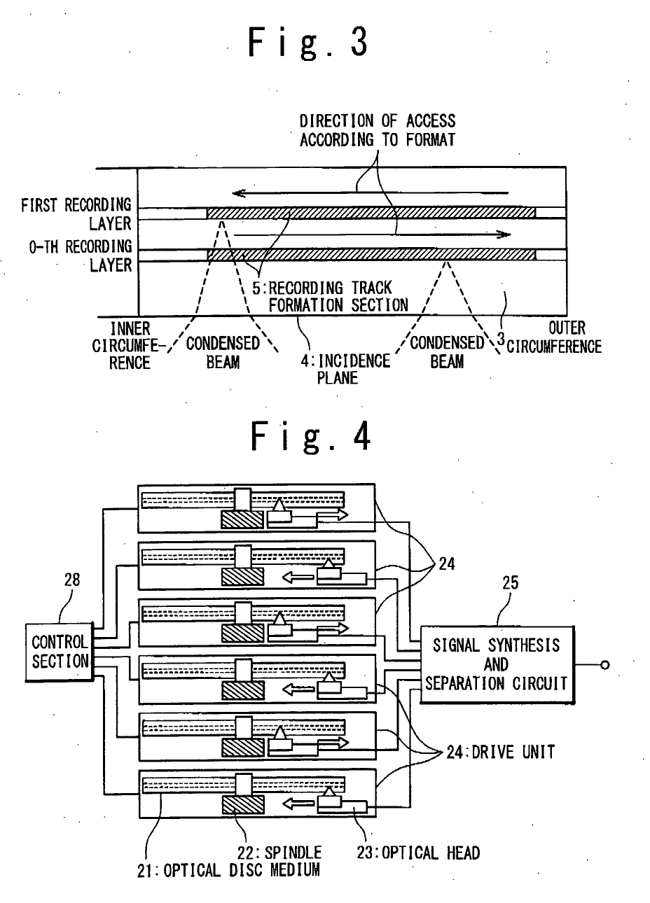

FIG. 4 is a block diagram illustrating a configuration of the optical disc drive device according to the embodiment of the present invention. The optical disc drive device includes: a plurality of drive units 24; a signal synthesis and separation circuit 25 connected to all of these drive units 24; and a control section 28 that controls operation of each of the drive units 24. Each drive unit 24 includes: a spindle 22 that rotates an optical disc medium 21; and an optical, head 23 that performs recording or reproducing. In each drive unit 24, the optical disc medium 21 is set at the spindle 22 when needed. The plurality of drive units 24 simultaneously performs a recording/reproducing operation. At this point, the control section 28 performs control such that almost half of the units performing the operation access the recording layers in the first format and the remaining units access the recording layers in the second format.

The total number of drive units 24 is preferably an even number, and the drive units 24 that access the recording layers in the first format and the drive units 24 that access the recording layers in the second format are preferably divided into halves. However, the total number of drive units 24 may be an odd number, and the number of the drive units 24 that access the recording layers in the first format and the number of the drive units 24 that access the recording layers in the second format may not necessarily agree with each other.

At time of reproducing, data read from the optical disc media 21 by the optical heads 23 in the respective drive units 24 are synthesized by the signal synthesis and separation circuit 25, and then outputted as a signal of a substantially constant data transfer velocity. At time of recording, the signal synthesis and separation circuit 25 performs division into signals of transfer velocities respectively required for the drive units 24 and transmits them, and each optical head 23 performs recording on the respective optical disc medium 21. Note that the signal synthesis and separation circuit 25 may include a function of the control section 28.

While the drive units that access the recording layers in the first format access an inner circumference side, the drive units 24 that access the recording layers in the second format access an outer circumference side. While the drive units 24 that access the recording layers in the first layer access the outer circumference side, the drive units 24 that access the recording layers in the second format access the inner circumference side. With such positional relationship, even in a case where the optical disc medium 21 constantly rotates with a limit number of revolutions, a data transfer velocity of data obtained by synthesizing reproduction signals outputted from the plurality of drive units 24 can always be kept substantially constant. That is, the present invention has an advantage that, while having a configuration that uses a plurality of optical disc media with the same structure, a high transfer velocity can be maintained without requiring waste of access time.

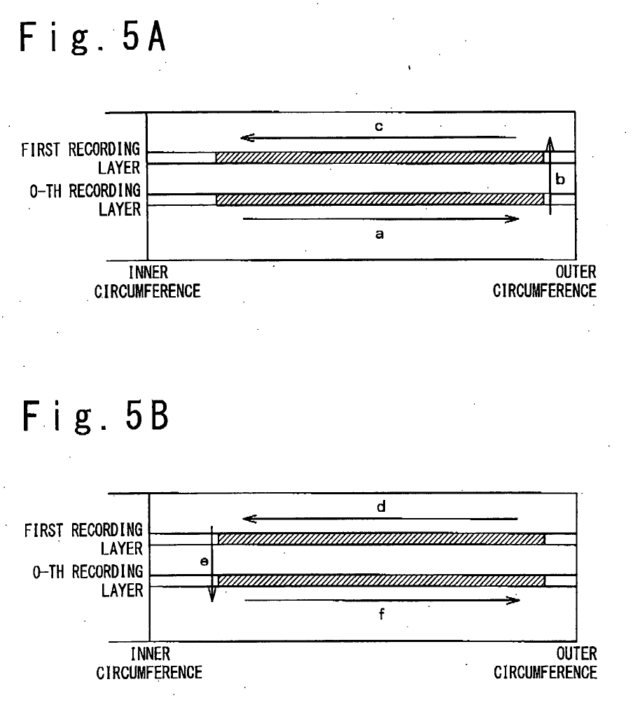

FIGS. 5A and 5B are sectional views illustrating access sequence in an optical disc including a plurality of recording layers in different formats. FIG. 5A is a diagram showing the access sequence in a case where the first recording layer is accessed after a 0-th recording layer. FIG. 5B is a diagram showing the access sequence in a case where the 0-th recording layer is accessed after the first recording layer.

For example, in a case where is used the two-layer optical disc medium with. the 0-th recording layer in the first format and with the first recording layer in the second format, the access sequence is as shown in FIGS. 5A and 5B. Specifically, half of the drive units, as shown in FIG. 5A, after accessing the 0-th recording layer (arrow a), move to the first recording layer through interlayer jumping at an outer circumferential end (arrow b) and then performs accessing (arrow c). The remaining drive units, as shown in FIG. 5B, after accessing the first recording layer (arrow d), move to the 0-th recording layer through interlayer jumping at an inner circumferential end (arrow e) and then performs accessing (arrow f). The interlayer jumping is performed by moving a focal point of laser light irradiated from the optical head from the 0-th recording layer to the first recording layer or from the first recording layer to the 0-th recording layer, and thus it does not require much time for the movement.

When recording or reproducing is performed on the 0-th recording layer and the first recording layer in succession, timing of the interlayer jumping may slightly differ among the drive units 24. However, by providing a buffer memory of adequate capacity in the signal synthesis and separation circuit 25, the timing difference can easily be absorbed.

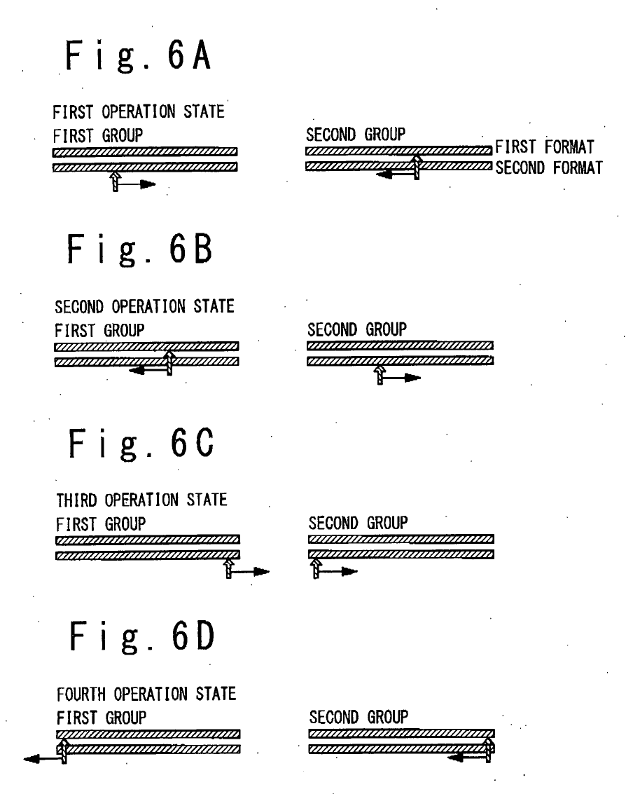

The present invention is also applicable to a case where a capacity of the first format and a capacity of the second format differ from each other. FIGS. 6A to 6D are pattern diagrams illustrating four examples of operation states in such a condition in the optical disc medium with the two-layer structure. The plurality of drive units, when divided into a first group and a second group, are controlled in a manner such that the following four operation states are provided.

A first operation state, as shown in FIG. 6A, is an operation state in which the second group of drive units performs recording or reproducing on the recording layers in the second format while the first group of drive units performs recording or reproducing on the recording layers in the first format. A second operation state, as shown in FIG. 6B, is an operation state in which the second group of drive units performs recording or reproducing on the recording layers in the first format while the first group of drive units performs recording or reproducing on the recording layers in the second format. A third operation state, as shown in FIG. 6C, is an operation state in which the second group of drive units performs recording or reproducing on the vicinity of an inner circumferential section in the recording layers in the first format while the first group of drive units performs recording or reproducing on the vicinity of an outer circumferential section in the recording layers in the first format. A fourth operation state, as shown in FIG. 6D, is an operation state in which the second group of drive units performs recording or reproducing on the vicinity of an outer circumferential section in the recording layers in the second format while the first group of drive units performs recording or reproducing on the vicinity of an inner circumferential section in the recording layers in the second format.

In a case where the capacity of the recording layers in the first format is larger than the capacity of the recording layers in the second format, even when the first operation state results from starting operation at an inner circumferential end of the recording layers in the first format and at an outer circumferential end of the recording layers in the second format, movement from the recording layer in the second format to the recording layer in the first format occurs first in the second group of drive units, and thus the third operation state arises before transition to the second operation state occurs. That is, in a case where continuous recording or reproducing of the entire capacity is performed, transition involving the three operations states, i.e., the first operation state →the third operation state→the second operation state results.

In a case where the capacity of the recording layers in the second format is larger than the capacity of the recording layers in the first format, even when the first operation state results from starting operation at the inner circumferential end of the recording layers in the first format and at the outer circumferential end of the recording layers in the second format, movement from the recording layer in the first format to the recording layer in the second format occurs first in the first group of drive units, and thus the fourth operation state arises before transition to the second operation state occurs. That is, in a case where continuous recording or reproducing of the entire capacity is performed, transition involving the three operations states, i.e., the first operation state→the fourth operation state→the second operation state results.

Considering the above proves that three of the four operation states in FIGS. 6A to 6D are basically used when there is a capacity difference. It is also proved that the third or fourth operation state is determined by the capacity difference between the two formats. More precisely, when recording or reproducing is performed on the optical disc medium at a constant rotation velocity, a difference in access time between the two formats are determined by a difference in the number of spiral tracks in a radial direction between the two formats. This difference in the number of tracks is almost equal to the capacity difference. With a small difference, the third or fourth operation state occurs only in the vicinity of the inner circumferential end and the vicinity of the outer circumferential end. Thus, the data transfer velocity of the data obtained by synthesizing the reproduction signals from the first group of drive units and the second group of drive units can be kept at a substantially constant value without great variation.

The actual recording/reproducing operation involves not only continuous operation but also operation at a random recording position. The fact still remains that relationship between relevant recording positions in the recording layers in the respective formats when a series of data signals are divided and then recorded onto a plurality of optical disc media results in relationship between the two types of access positions described in the four operation states above.

It is preferable that in the optical disc drive device, the number of simultaneously driven drive units 24 be an even number and that the numbers of the recording layers in the first format and the recording layers in the second format simultaneously accessed be equal to each other. However, for the drive unit whose recording layers in the two formats are not paired thus leaving a fraction, it is also possible to keep the data transfer velocity of the synthesized data constant by, for example, driving the entire surface of the optical disc medium at a constant linear velocity (CLV).

Moreover, in the case where the number of recording layers in the optical disc medium 21 is an odd number, there may also arises a need for a way of keeping the data transfer velocity constant in a pair of the recording layers in the same format. In such a case, a way of performing division into a plurality of sectors in a radial direction and then achieving access in a backward direction in a pseudo manner is needed. The advantage of the present invention can still be used upon access to the remaining recording layers.

Moreover, the numbers of recording layers of the optical disc media 21 simultaneously driven do not have to be necessarily equal to each other, but use of optical disc media with the same number of recording layers makes control easier.

The plurality of optical disc media 21 may be stored as one package in one cartridge and loaded in the respective drive units 24 upon recording or reproducing. Moreover, as shown in FIG. 4, an example where one optical disc medium 21 is set in one drive unit 24 is illustrated, but a plurality of optical disc media 21 may be set in one drive unit 24. Moreover, a type such that a plurality of optical disc media 21 is set at one spindle 22 is acceptable.

In the optical disc drive device according to the present invention, the optical disc medium used needs to have the features described above. Therefore, the present invention can be considered as an optical disc recording/reproducing system combining an optical disc drive and an optical disc medium.

The present invention has been described above with reference to the embodiment, but the present invention is not limited to the embodiment described above. Various modifications understandable to those skilled in the art can be made to configuration and details of the present invention within the scope of the present invention.

This application is based upon and claims the benefit of priority from the corresponding Japanese Patent Application No. 2008-082969, disclosed contents of which are incorporated herein by reference.

1-10. (canceled)

11. An optical disc drive device comprising:
a plurality of drive units configured to record on or reproduce from an optical disc medium which includes a plurality of recording layers with a spiral track formed thereon and is recorded or reproduced with a light entering from a same incidence plane through a transparent substrate,
wherein almost half of said plurality of recording layers provided in each optical disc media is in a first format in which recording or reproducing is performed along said spiral track to be scanned from an inner circumference to an outer circumference,
wherein a remaining almost half of said plurality of recording layers is in a second format in which recording or reproducing is performed along said spiral track to be scanned from said outer circumference to said inner circumference,
wherein said plurality of drive units are divided into a first group of drive units and a second group of drive units provided in almost a same quantity as that of said first group to be controlled; and
a control section configured to control an operation of said first group of drive units and said second group of drive units in a manner such that a first operation state and a second operation state are provided,
wherein said first operation state is an operation state in which said second group of drive units performs recording on or reproducing from said recording layers in said second format while said first group of drive units performs recording on or reproducing from said recording layers in said first format, and
wherein said second operation state is an operation state in which said second group of drive units performs recording of or reproducing from said recording layers in said first format while said first group of drive units performs recording on or reproducing from said recording layers in said second format.

12. The optical disc drive device according to claim 11,
wherein said control section is configured to control an operation of said first group of drive units and said second group of drive units in a manner such that at least one of a third operation state or a fourth operation state is further provided,
wherein said third operation state is an operation state in which said second group of drive units performs recording or reproducing on a vicinity of an inner circumferential section in said recording layers in said first format while said first group of drive units performs recording or reproducing on a vicinity of an outer circumferential section in the recording layers, and
wherein said fourth operation state is an operation state in which said second group of drive units performs recording or reproducing on said vicinity of an outer circumferential section in said recording layers in said second format while said first group of drive units performs recording or reproducing on said vicinity of an inner circumferential section in said recording layers in said second format.

13. The optical disc drive device according to claim 12,
wherein said first format recording layers and said second format recording layers of said optical disc medium are alternatively stacked.

14. The optical disc drive device according to claim 13,
wherein said optical disc medium comprises two recording layers.

15. The optical disc drive device according to claim 14,
wherein a sequential data file is distributed to said plurality of optical disc media for recording thereon or a sequential data file distributed to said plurality of optical disc media is reproduced therefrom.

16. The optical disc drive device according to claim 15,
wherein said plurality of optical disc media are stored in a cartridge as one package and loaded therefrom to said plurality of optical disc drive units respectively.

17. The optical disc drive device according to claim 16,
wherein a capacity of a recording layer in said first format and a capacity of a recording layer in said second recording layer are different.

18. An optical disc medium recording/reproducing method comprising:
a plurality of drive units recording or reproducing data on or from a plurality of optical disc media,
wherein each of said plurality of optical disc media comprises a plurality of recording layers,
wherein a spiral track is formed on each of said plurality of recording layers,
wherein said each recording layer can perform recording or reproducing with light entering from a same incidence plane through a transparent substrate,
wherein almost half of said plurality of recording layers has a first format in which recording or reproducing is performed along the spiral track to be scanned from inner circumference to outer circumference,
wherein a remaining almost half of said plurality of recording layers has a second format in which recording or reproducing is performed along the spiral track to be scanned from the outer circumference to the inner circumference, and
wherein said performing in a plurality of drive units comprises:
dividing said plurality of drive units into a first group and a second group;
performing recording or reproducing in a first operation state in which said second group of drive units performs recording or reproducing on said recording layers in said second format while said first group of drive units performs recording or reproducing on said recording layers in said first format; and
performing recording or reproducing in a second operation state in which said second group of drive units performs recording or reproducing on said recording layers in said first format while said first group of drive units performs recording or reproducing on said recording layers in said second format.

19. The optical disc medium recording/reproducing method according to claim 18, further comprising at least one of:
performing recording or reproducing in a third operation state in which said second group of drive units performs recording or reproducing on a vicinity of an inner circumferential section in said recording layers in said first format while said first group of drive units performs recording or reproducing on a vicinity of an outer circumferential section in the recording layers in the first format; or
performing recording or reproducing in a fourth operation state in which said second group of drive units performs recording or reproducing on said vicinity of an outer circumferential section in said recording layers in said second format while said first group of drive units performs recording or reproducing on said vicinity of an inner circumferential section in said recording layers in said second format.

20. The optical disc medium recording/reproducing method according to claim 19, further comprising:
distributing a sequential data file in order to record on said plurality of optical disc media; and
reassembling said sequential data file distributed to and recorded on said plurality of optical disc media according to a reproducing signal outputted from said plurality of optical disc media.
